(19) United States
(12) Patent Application Publication
(10) Pub. No.: US 2026/0231912 A1
(43) Pub. Date: Aug. 13, 2026

(54) METHODS AND SYSTEMS FOR INFLUENCING AQUATIC ANIMALS' COLOR

(71) Applicant: SIGNIFY HOLDING B.V., EINDHOVEN (NL)

(72) Inventors: MATHAN KUMAR GOPALSAMY, MEDFORD, MA (US); PETER DEIXLER, ARLINGTON, MA (US); JAEHAN KOH, CHESTNUT HILL, MA (US)

(21) Appl. No.: 19/156,978

(22) PCT Filed: Feb. 16, 2024
(86) PCT No.: PCT/EP2024/053983

§ 371 Date: Aug. 15, 2025

Related U.S. Application Data
(60) Provisional application No. 63/449,355, filed on Mar. 2, 2023.

(30) Foreign Application Priority Data
Mar. 24, 2023 (EP) 23164103.6

(51) Int. Cl. A01K 63/06; A01K 61/10; A01K 61/59

(52) U.S. Cl. CPC A01K 63/06; A01K 61/10; A01K 61/59

(57) ABSTRACT

A computer-implemented method is disclosed for controlling conditions within a volume of water containing aquatic animals. The method comprises obtaining target color information indicating a target color of the aquatic animals in the volume of water. The method also comprises, preferably via an input interface described herein, obtaining existing color information indicating an existing color of the aquatic animals in the volume of water. Then, the method comprises determining, based on the target color of the aquatic animals and based on the existing color of the aquatic animals and based on a model associating characteristics of light provided to the aquatic animals to effects on color and/or color development of the aquatic animals, a light recipe for the aquatic animals. Also, the method comprises providing the determined light recipe to the aquatic animals, so as to influence the aquatic animals' color towards the target color.

### FIELD OF THE INVENTION

This disclosure relates to a computer-implemented method for controlling conditions within a volume of water, in particular to such method where a light recipe is provided for influencing the color of aquatic animals. This disclosure further relates to a controller, a system and computer program for performing the methods described herein.

### BACKGROUND

Body color and visual appeal of aquatic species (such as salmonid fish, shrimp etc.) have large impact on their market value. For example, consumers prefer and pay a premium for (a) salmon fillet that are deep red or pink (b) black tiger shrimp (P. monodon) that are vibrantly red (b) whiteleg shrimp (P. vannamei) that are lighter.

The color of wild caught salmon/shrimp are known to be more vibrant than their farm-raised counterparts due to abundance carotenoids in their natural diet. Aqua farmers compensate this by adding carotenoids (natural or synthetic) to fish/shrimp feed to promote body color. Such additives not only very significantly add to farm's feed costs but also do not guarantee uniform color distribution across every farmed animal.

The pigmentation of fish and crustaceans is a natural phenomenon that is part of their natural life cycle and in which carotenoids play a dominant role. Among aquaculture species, particularly salmonid fish and shrimp, color is an important quality criterion for consumers. For instance, the market acceptability of fishes depends on pigmentation, one of the considerable attributes for determining quality in the eyes of the consumer. A similar case is evident in the aquatic ornamental industry, in which most fish species are selected and kept based on their attractive skin color. Carotenoids are widely used as pigmenting sources in aquaculture feed and their relevance to enhancing the sensory and color quality of fish and crustaceans.

However, the use of pigmenting compounds in the aquaculture industry doesn't come cheap. It is the most expensive element of salmon/shrimp feed, according to a study, taking up nearly 20% of total feed costs. Controlling and optimizing the concentration of pigmenting compounds in aquatic animals' feed is time and labor intensive, study authors found.

In light of the above, there is a need in the art for improved methods and systems for influencing the color of aquatic animals.

US 2016/0353716 A1 discloses a fish lighting system having an input interface which receives instructions corresponding to a desired fish behavioral and/or physiological response. This is converted into a lighting control signal (RGB, t) for driving a lighting arrangement, with the intensity and color of the output from the lighting arrangement selected to obtain the desired fish behavioral and/or physiological response.

### SUMMARY

To that end, a computer-implemented method is disclosed for controlling conditions within a volume of water containing aquatic animals. The method comprises obtaining target color information indicating a target color of the aquatic animals in the volume of water. The method also comprises, preferably via an input interface described herein, obtaining existing color information indicating an existing color of the aquatic animals in the volume of water. Then, the method comprises determining, based on the target color of the aquatic animals and based on the existing color of the aquatic animals and based on a model associating characteristics of light provided to the aquatic animals to effects on color and/or color development of the aquatic animals, a light recipe for the aquatic animals. Also, the method comprises providing the determined light recipe to the aquatic animals, so as to influence the aquatic animals' color towards the target color.

An aspect of this disclosure relates to a controller that is configured to control an illumination system that is configured to provide artificial light to aquatic animals contained in a volume of water. The controller comprises an input interface for obtaining target color information indicating a target color of the aquatic animals in the volume of water and for obtaining existing color information indicating an existing color of the aquatic animals in the volume of water/The controller also comprises a processor configured to determine, based on the target color of the aquatic animals and based on the existing color of the aquatic animals, a light recipe for the aquatic animals. The controller further comprises an output interface for sending control signals to the illumination system for causing the illumination to provide artificial light to the aquatic animals in accordance with the light recipe.

An aspect of this disclosure relates to a system for controlling conditions within a volume of water containing aquatic animals. The system comprises an illumination system that is configured to provide artificial light to the aquatic animals and any of the controllers described herein.

These method, controller and system provide for an improved way of influencing the color of aquatic animals. Recent studies have established that lighting conditions, in addition to diet, influence the body color of farmed aquatic animals.

To illustrate, the photoperiod, which may be understood as the period of time within a 24-hour time frame that light is available, may influence the body color of shrimp (see Lakshmi, G. J., A. Venkataramiah, and G. Gunter. “Effects of salinity and photoperiod on the burying behavior of brown shrimp Penaeus aztecus Ives.” Aquaculture 8.4 (1976): 327-336). Salmon, for example, have been shown to exhibit different fillet colors when farmed during summer and winter seasons.

Further, light intensity is known to impact body color of cultured shrimps (.Tseng, K. F., H. M. Su, and M. S. Su. 1998. Culture of Penaeus monodon in a recirculating system. Aquaculture Engineering 17:138-147). Free astaxanthin concentration (FAC) in wild shrimp was higher than in lab-cultured shrimps as natural sunlight intensity (no less than 10,000 1×) was much higher than light intensity in the labs (max 2500 1×). Researchers have demonstrated that FAC levels were higher in shrimps which were illuminated with high intensity light regime compared to the ones with exposure to lower intensity treatments (Erickson M C, Bulgarelil M A, Resurreccion A V A, Vendetti R A, Gates K A (2007) Consumer differentiation, acceptance, and demographic patterns to consumption of six varieties of shrimp. Journal of Aquatic Food Product Technology 15:35-51).

Also, reflected light in water, specifically the spectrum of the light, is known to impact shrimp's body color ([11] Parisenti J, Beirão L H, Tramonte V L C G, et al. Preference ranking of colour in raw and cooked shrimps International Journal of Food Science & technology. 2011., 2011b). For example, reflected light in tanks influences coloration in peppermint shrimps (You K, Yang H, Liu Y, Liu S, Zhou Y, et al. (2006) Effects of different light sources and illumination methods on growth and body color of shrimp Litopenaeus vannamei. Aquaculture 252: 557-565). In another study, researchers disclosed that diet and background color of the aquaculture tank have significant effect on Giant Tiger Prawn (Penaeus monodon). Shrimps have responded in as quick as 15 min after being transferring from a black container to a white container (Calvo, Natalia S., et al. “Reflected-light influences the coloration of the peppermint shrimp, Lysmata boggessi (Decapoda: Caridea).” Journal of the World Aquaculture Society 47.5 (2016): 701-711).

The lighting conditions are also known to influence the number of pathogens and priobiotic microbes in water, which correlate with body color of aquatic animals. It is well known that the presence of probiotic microbes as well as pathogenic bacteria in the tank water affects the microbiome inside the fish's or shrimp's body. For instance, for Atlantic Salmon (Nguyen, Chan D H, et al. “Atlantic Salmon (Salmo salar L., 1758) gut microbiota profile correlates with flesh pigmentation: cause or effect?” Marine Biotechnology (2020): 1-19) it has been found that the salmon's gut microbiota profile correlates with flesh pigmentation.

Similarly, the microbiome within shrimps affect the appearance of their digestive tract. It is also known that the administered light spectrum affects the concentration of the probiotic microbes in an aquaculture tank water, which consequently modifies the microbiome of the shrimp.

Further, [Kang & Kim; Influence of density and background color to stress response, appetite, growth, and blind-side hypermelanosis of flounder, Paralichthys olivaceus; Fish Physiol Biochem (2013) 39:221-232] studied for the aquaculture fish olive flounder, Paralichthys olivaceus, the relevance of density and background color to malpigmentation (hypermelanosis) on the blind side. The study reared two duplicate groups of juveniles in flat-bottom aquaria with dark-green (control) and white backgrounds for 120 days. The study also indicated that the inhibitory effect of a bright background color on hypermelanosis is density dependent.

Coloration of crustaceans, such as shrimp, can be manipulated by changes in reflected light in tank. As with other aquatic animals, shrimps cannot synthesize carotenoids themselves and hence are depending primarily on dietary sources both in a farm setting (e.g. astaxanthin in feed pellets) or in a natural habitat (microalgae and phytoplankton). Crustaceans' visual system and dietary system still controls how carotenoids are converted and bound within cells in the body. Such a process is heavily influenced by environmental conditions, including lighting conditions. Crustaceans are for example known to regulate their body color between dark (when in murky waters) and light (when in sunlit tropical waters). Shrimp's ability to adapt body coloration plays an important role in escaping predators through camouflaging with the environment.

Thus, coloration of aquatic animals is a complex process and can be aided greatly by adapting the lighting conditions, the lighting recipe, in real-time because every batch of harvest is different. The technology disclosed herein enables to continuously monitor and adapt the light recipe to influence the body color of species towards farmer's harvest goals.

As referred to herein, the conditions within the volume of water may be understood as the circumstances or factors affecting the color and/or color development of the aquatic animals in the volume of water.

As used herein, “color of the aquatic animals” may be understood to refer to the color of the animals, in particular of the body of the animals, as perceived by a human observer who is looking at the aquatic animals.

The volume of water may be a volume of water in a fish tank, for example.

The existing color information may in particular indicate, for each of a plurality of aquatic animals, the existing color that that aquatic animals in question has. Thus, the color information may indicate a color distribution of the aquatic animals in the sense that it indicates how many aquatic animals have which color.

A light recipe may be understood to indicate for each of a plurality of times, the light that is to be provided to the aquatic animals. In particular, the light recipe may be understood to define, for each of the plurality of times, the lighting conditions that should be present in the volume of water. The light recipe may for example indicate, a spectrum of the light that is to be provided to the aquatic animals and/or a total radiant flux that the aquatic animals should receive. The light recipe for example defines a photoperiod. Optionally, the light recipe also defines, for each of the plurality of times, where in the volume of water which light is to be provided. Providing the determined light recipe may be performed by sending appropriate one or more control signals to an illumination system so that the one or more control signal cause the illumination system to provide light to the aquatic animals in accordance with the light recipe.

The light as indicated by the light recipe may refer to all of the light that the aquatic animals receive, including both artificial light and non-artificial light, such as sunlight. Alternatively, the light as indicated by the light recipe may refer specifically to the artificial light that should be provided to the aquatic animals, optionally in addition to sunlight.

The target color may be the color that is desired for the aquatic animals at the time of harvest.

The aquatic animals may comprise crustaceans such as crustaceans belonging to the superfamily Penaeoidea, preferably to the families Aristeidae or Penaeidae, such as gamba shrimps and/or tiger prawns and/or whiteleg shrimps and/or Atlantic white shrimps and/or Indian prawns. Additionally or alternatively, the aquatic animals comprise fish such as Grass carp, Silver carp, Common carp, Nile tilapia, Bighead carp, Catla (Indian carp), Crucian carp, Atlantic salmon, Roho labeo, Milkfish, Rainbow trout, Wuchang bream, Black carp, Northern snakehead, Amur catfish, et cetera.

In an embodiment, the method comprises determining, based on the target color of the aquatic animals and based on the existing color of the aquatic animals and based on a model associating characteristics of feed provided to the aquatic animals to effects on color and/or color development of the aquatic animals, determining feed, in particular characteristics of feed, for the aquatic animals. In such case, providing the determined feed may be performed by sending one or more appropriate control signals to a feed system.

In an embodiment, the system comprises one or more imaging systems that are configured to measure the existing color of aquatic animals within the volume of water.

This embodiment is advantageous in that it enables to monitor the existing color of the aquatic animals continuously.

The one or more imaging systems may be configured to record one or more images of aquatic animals in the volume of water and subsequently perform image processing in order to determine the color of the aquatic animals that are present in the recorded one or more images. The processing may be performed by the processor of the controller. In that sense the imaging systems may be partially embodied within the controller.

The computer-implemented may comprise, and the controller, in particular the processor of the controller, may be configured for, constructing the model based on training data, the training data associating a plurality of light recipes with respective effects on color of aquatic animals, and using the constructed model to determine the light recipe and/or the second light recipe referred to below.

These embodiments enable to automatically determine the appropriate light recipe for influencing the color of the aquatic animals to the target color.

Constructing the model may be performed as part of a machine-learning method known in the art.

Training data can be obtained quite simply, namely by recording, for numerous batches, throughout the lifecycle of each batch, several parameters including the existing lighting conditions together with the existing color of the aquatic animals. The lighting conditions may for example comprise a spectrum of light that is provided to the aquatic animals and/or a radiant power of the light provided to the aquatic animals, et cetera. Then, machine-learning methods known in the art can construct a model based on the training data so that the model outputs, when a set of parameters including lighting conditions is input, a prediction on how the color of the aquatic animals' changes.

The training data may associate further one or more parameters as well with the respective effect on color of aquatic animals. The method may further comprise, and the controller may comprise one or more sensors for, measuring one or more values of the one or more parameters. The constructed model may then be used to, based on the measured one or more values of the one or more parameters, determine the light recipe and/or the second light recipe referred to below. The one or more parameters comprise at least one of
a turbidity of the water,
a velocity of the water,
a water temperature,
an amount of oxygen in the water,
a pH of the water,
amount and/or type of pathogens in the water,
amount and/or type of probiotic microbes in the water,
amount and/or type of pathogenic microbes in the water
amount and/or type of feed.

In principle, the more parameters are used for constructing the model, and the more parameters are then input into the constructed model, the more accurate the color development of the aquatic animals can be predicted. This will lead to more effective light recipes in the sense that the color of the aquatic animals can be effectively influenced.

In an embodiment, the light recipe indicates, for each of a plurality of times, an electromagnetic spectrum and/or radiant flux of artificial light. Providing the determined light recipe to the aquatic animals then preferably comprises causing an illumination system to provide artificial light to the aquatic animals in accordance with the light recipe.

The light recipe may also indicate one or more positions within the volume of water where artificial light is provided. The light recipe may depend on the current location of the fish (e.g., the depth of the fish or the 3D position of the fish). The light recipe may depend on the density of the fish.

The method may comprise, and the controller, in particular the processor of the controller, may be configured for determining feed, in particular characteristics of feed, for the aquatic animals based on the target color of the aquatic animals and based on the existing color of the aquatic animals and based on a model associating characteristics of feed provided to the aquatic animals to effects on color and/or color development of the aquatic animals.

Such model may be constructed based on feed training data associating a plurality of feed characteristics with respective effects on color of aquatic animals.

In such embodiment the determined characteristics of the feed may comprise at least one of:
a composition of the feed,
a size of feed pellets,
an amount of feed,
a feeding schedule indicating at what times feed is provided.

The amount of feed may be an amount of feed per unit of time, e.g., per day.

Preferably, the feeding schedule indicates how much feed is provided at what times.

Providing the determined feed may comprise sending appropriate control signals to a feed system in order to cause the feed system to provide the determined feed to the aquatic animals.

This embodiment further improves the abilities to influence the color of the aquatic animals because the color of the aquatic animals also depends on feed.

The target color information may indicate the target color of the aquatic animals for a future time. Further, the existing color information may indicate the existing color of the aquatic animals for a particular time before the future time. In such case, the method may comprise, and the controller may be configured for, obtaining desired color trajectory information indicating how the color of the aquatic animals is desired to develop in a time period before the future time such that the aquatic animals have the target color at the future time and indicating for each of one or more times before the future time, a desired color of the aquatic animals. Herein the one or more times comprise the particular time. Then, the method may comprise, and the controller, in particular the processor of the controller, may be configured for, determining, based on a comparison between the existing color of the aquatic animals as indicated by the existing color information and the desired color of the aquatic animals at the particular time as indicated by the desired color trajectory information, the light recipe and providing the determined light recipe to the aquatic animals.

These embodiments allow to assess whether a batch of aquatic animals is expected to have, at the future time, the color as targeted. The desired color trajectory information may be understood to indicate a desired color development of the aquatic animals over time that leads to the target color at the future time. The desired color development may be some default color development for the given species of aquatic animals. The desired color trajectory information may indicate a time of harvest for the aquatic animals. The desired color development is for example an average of how the color developed in previous batches for the same species. If it is determined, early in the process, i.e., ahead of the future time, that the current existing color of the aquatic animals is not on the color trajectory, then it may be concluded that the aquatic animals will not reach the target color at the future time unless measures are taken to influence the color (development) of the aquatic animals. The determined light recipe preferably incorporates some of these measures, such as a longer/shorter photoperiod, a higher/lower radiant flux as received by the aquatic animals.

Preferably the determined light recipe defines the characteristics of the light provided to the aquatic animals for a time period between the particular time up to and including the future time.

As described herein, a step of comparing existing color with a desired color may be understood as determining whether a difference between the existing color and the desired color is higher than a threshold value. Then, based on the determination that the difference is indeed higher than the threshold value, may the light recipe be determined, or the second light recipe referred to below. In particular, if it is determined that the difference between the existing color and the desired color is larger than the threshold value, then, in response, it may be checked whether another light recipe can be put in place that enables to reach, or to approach better, the target color at the future time.

The existing color of the aquatic animals may be repeatedly, e.g., continuously, measured so that it can be repeatedly, e.g., continuously, be checked whether the existing color development (as indicated by existing color trajectory information) deviates, and optionally to what extent it deviates, from the desired color development as indicated by desired color trajectory information. If the deviation becomes too large, then a new light recipe and associated color trajectory information. Of course, this cycle can be repeated over and over again so that the aquatic animals are provided with an appropriate light recipe most of time.

In an embodiment, the method comprises, and the controller, in particular the processor of the controller is configured for, determining, based on the determined light recipe, second color trajectory information indicating how, by providing the determined light recipe, the color of the aquatic animals is desired to develop in a time period between the particular time and the future time and indicating, for each of one or more times between the particular time and the future time, a desired color of the aquatic animals, wherein the one or more times comprise a second particular time. In such embodiment, the method may comprise, and the controller, in particular the processor of the controller may be configured for, obtaining second existing color information indicating the existing color of the aquatic animals for the second particular time between the particular time and the future time. Then, the method may comprise, and the controller, in particular the processor of the controller may be configured for, comparing the existing color of the aquatic animals as indicated by the second existing color information and the desired color of the aquatic animals at the second particular time as indicated by the second color trajectory information.

Thus, this embodiment enables to continuously monitor whether a newly determined color trajectory is actually followed. If this is not the case, then again a new light recipe may be determined.

Preferably, of course, the second color trajectory leads to the target color at the future time. However, it may be that the target color cannot be achieved anymore at the future time. In that case, the second color trajectory is preferably such that the target color is approached at the future time as well as possible. Additionally or alternatively, the second color trajectory may show that the target color is reached some time period after the future time. In that case, it may be decided to postpone harvesting of the aquatic animals so that they will have the target color at the time of harvest.

In an embodiment, the method comprises, and the controller, in particular the processor of the controller is configured for, determining, based on comparing the existing color of the aquatic animals as indicated by the second existing color information with the desired color of the aquatic animals at the second particular time as indicated by the second color trajectory information, a second light recipe. Then, the method may comprise, and the controller may be configured for, providing the determined second light recipe to the aquatic animals so as to influence the aquatic animals' color towards the target color.

These embodiments clarify that indeed the existing color may be checked with any desired color as indicated by any desired color trajectory information that is currently “in force”. As used herein, desired color trajectory information that is said to be in force means the trajectory information has been determined based on the light recipe that is currently being provided to the aquatic animals. In other words, the existing color development of the aquatic animals should in principle follow the color development as indicated by the desired color trajectory information that is in force. If not, then another light recipe may have to be determined in order to influence the color of the aquatic animals.

The method may comprise, and the controller, in particular the processor of the controller, may be configured for, determining based on the determined second light recipe, third color trajectory information indicating how, by providing the determined second light recipe, the color of the aquatic animals is desired to develop in a time period between the second particular time and the future time.

The first color trajectory information as well as the determined second color trajectory information may indicate a time of harvest for the aquatic animals.

Preferably the method comprises, and the controller is configured for, causing the aquatic animals to be harvested at the time of harvest as indicated by the second color trajectory information.

The aquatic animals may crustaceans. Additionally or alternatively, the aquatic animals may comprise fish, preferably salmon. The color (development) of these types of aquatic animals is influenced by the light recipe that is provided.

A distinct aspect of this disclosure relates to a computer program comprising instructions which, when the instructions are performed by a data processing system, cause the data processing system to perform any of the computer-implemented methods described herein. The data processing system may be a controller as described herein.

This disclosure also relates to a computer-readable medium having stored thereon any of the computer programs disclosed herein.

A distinct aspect of this disclosure relates to a computer comprising:
a computer readable storage medium having computer readable program code embodied therewith, and
a processor, preferably a microprocessor, coupled to the computer readable storage medium, wherein responsive to executing the computer readable program code, the processor is configured to perform any of the computer-implemented methods described herein.

A distinct aspect of this disclosure relates to a computer program or suite of computer programs comprising at least one software code portion or a computer program product storing at least one software code portion, the software code portion, when run on a computer system, being configured for executing any of the computer-implemented methods described herein.

A distinct aspect of this disclosure relates to a non-transitory computer-readable storage medium storing at least one software code portion, the software code portion, when executed or processed by a computer, is configured to perform any of the computer-implemented methods described herein.

As will be appreciated by one skilled in the art, aspects of the present invention may be embodied as a system, a method or a computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a processor/microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of a computer readable storage medium may include, but are not limited to, the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present invention, a computer readable storage medium may be any tangible medium that can contain, or store, a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or a central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Moreover, a computer program for carrying out the methods described herein, as well as a non-transitory computer readable storage-medium storing the computer program are provided. A computer program may, for example, be downloaded (updated) to the existing data processing systems (e.g., to the existing controllers) or be stored upon manufacturing of these systems.

Elements and aspects discussed for or in relation with a particular embodiment may be suitably combined with elements and aspects of other embodiments, unless explicitly stated otherwise. Embodiments of the present invention will be further illustrated with reference to the attached drawings, which schematically will show embodiments according to the invention. It will be understood that the present invention is not in any way restricted to these specific embodiments.

### BRIEF DESCRIPTION OF THE DRAWINGS

Aspects of the invention will be explained in greater detail by reference to exemplary embodiments shown in the drawings, in which:

FIG. 1 illustrates a system for controlling conditions within a volume of water according to an embodiment;

FIGS. 2A-2D illustrate color trajectories according to an embodiment;

FIG. 3 is a flow chart illustrating a method according to an embodiment;

FIG. 4 illustrates a data processing system according to an embodiment.

### DETAILED DESCRIPTION OF THE DRAWINGS

In the figures, identical reference numbers indicate identical or similar elements.

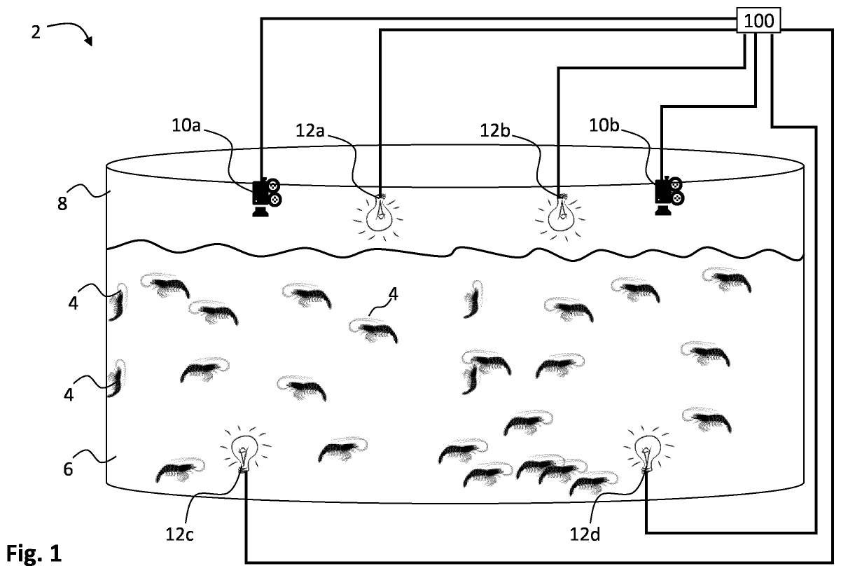

FIG. 1 illustrates a system 2 for controlling conditions, in particular lighting conditions, within a volume of water 6 containing aquatic animals 4, according to an embodiment. The system 2 comprises an illumination system 12 that is configured to provide artificial light to the aquatic animals 4. As shown, the illumination system 12 may comprise a plurality of light sources 12a, 12b, 12c, 12d. The system 2 also comprises a controller 100 that is configured to control the illumination system 12. The controller may for example be configured where in the volume of water 6 which artificial light is provided to the aquatic animals 4. In particular, the controller may be configured to control a radiant power of the artificial light as received by the aquatic animals and/or an electromagnetic spectrum (color) of the provided artificial light.

As shown in FIG. 1, the volume of water 6 may a volume of water within a fish tank in which the aquatic animals are grown. The fish may be grown in such fish tank until they have a certain size and may then be harvested.

The controller 100 comprises an input interface for obtaining target color information indicating a target color of the aquatic animals in the volume of water. Such input interface may be a user interface via which a user can input a certain target color for the aquatic animals 4 in question.

The embodiment of FIG. 1 also comprises a plurality of imaging systems 10a, 10b, which may for example be respective multi-spectral images (e.g. RGB imagers) inside the volume of water 6. These imaging systems may for example be configured to shortly, e.g., 1 second, illuminate part of the volume of water 6 with white light that aids to acquire images from which the color of the aquatic animals in those images can be derived. The imaging systems may comprise grow lights and/or flashlights embedded on them. Preferably, these imaging systems are attached to luminaires of the illumination system, to the fish tank, to a feeding tray/box or fish pen at locations suitable for capturing the fully body color of the aquatic animals (e.g., bottom of the floor, below automated feeders, lateral view).

In any case, the input interface of the controller allows the controller to receive existing color information indicating an existing color of the aquatic animals. Such color information may be embodied as the images captured by the imaging systems. The controller, in particular the processor of the controller may then run an algorithm known in the art to identify the aquatic animals in the recorded images and determine the color, e.g., the body color, of the identified aquatic animals.

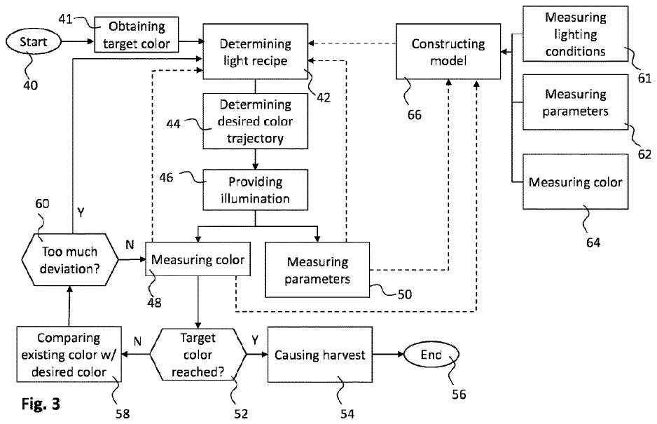

The processor of the controller 100 is then configured to determine, based on the target color of the aquatic animals and based on the existing color of the aquatic animals, a light recipe for the aquatic animals. A light recipe may be understood to indicate which light, e.g. which radiant flux and which electromagnetic spectrum, is to be provided at which times, optionally also at which positions in the volume of water 6. FIG. 3 explains in more detail how the controller may determine an appropriate light recipe.

The controller 100 also comprises an output interface for sending control signals to the illumination system 12 for causing the illumination system to provide artificial light to the aquatic animals in accordance with the light recipe.

Although FIG. 1 schematically depicts shrimps as aquatic animals 4, in principle, the technology disclosed herein can be advantageously used for any aquatic animals the color of which depends on the lighting conditions.

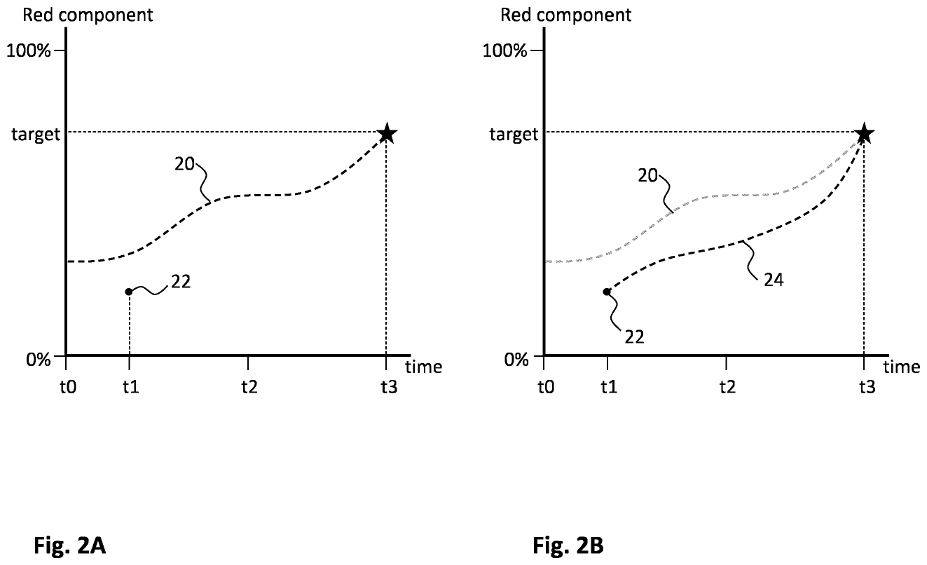

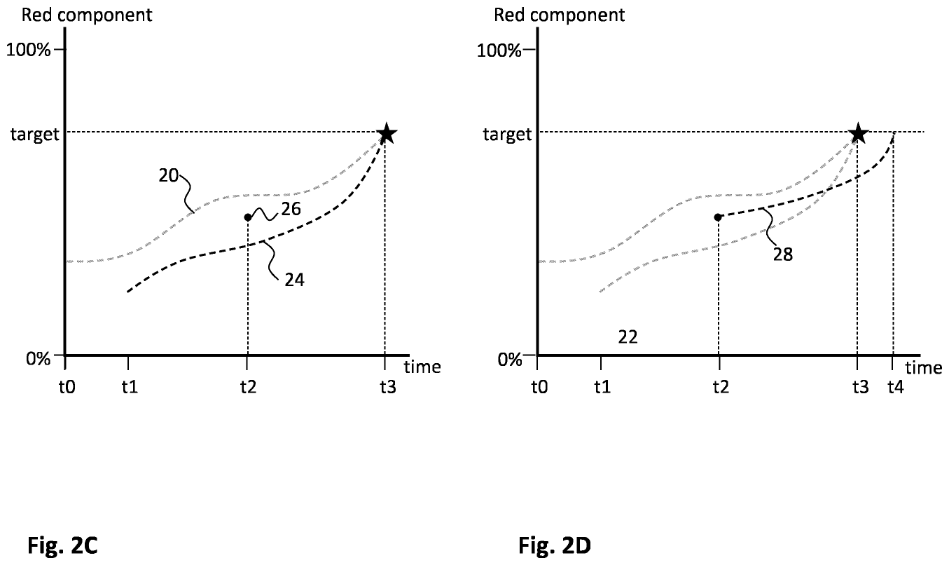

FIG. 2A is a graph showing a desired color trajectory 20. The horizontal axis indicates time and the vertical axis the red component of the existing color of the aquatic animals as measured for example by the imaging system 12 described with reference to FIG. 1. The red component is for example the red component of an RGB color coding scheme. As indicated, the target color for the aquatic animals, for the red component, is roughly 75%. It should be appreciated that, for clarity, FIGS. 2A-2D only show the target value and color trajectory for the red component, however, typically, the target value is defined based on more value, e.g., based on all three values of an RGB color coding scheme. In such case, the color trajectory would have four dimensions (the three RGB-values and time).

FIG. 2A also shows that the color trajectory indicates a time of harvest at t3. Thus, at t3, the color of the aquatic animals is desired to reach the target value.

Color trajectory 20, which may be indicated by color trajectory information described herein, may be a default color trajectory for the given species of the aquatic animals.

At time t1, the existing color of the aquatic animals is measured as indicated by point 22. It should be appreciated that the measured existing color may be an average color, in this case an average red component percentage, of several aquatic animals at or around t1. In any case, the existing color has a too low red component percentage relative to color trajectory 20.

Hence, a new light recipe is determined, which is associated with a new color trajectory 24 shown in FIG. 2B. The color trajectory 24 also leads to the target color at time t3.

As shown in FIG. 2C, at time t2 again the existing color of the aquatic animals is measured (see point 26). Therefore, another light recipe is determined which is associated with color trajectory 28 (see FIG. 2D). Unfortunately, color trajectory 28 does not reach the target color at time t3, however, does reach the target color at time t4. In light of this, a farmer may decide to postpone the time of harvest so that the aquatic animals will hopefully have the target color at time t4.

FIG. 3 is a flow chart illustrating a computer-implemented method according to an embodiment. The method starts at step 40 and then continues to step 41, which comprises obtaining target color information indicating a target color of the aquatic animals in the volume of water. Preferably, the target color is the color that the aquatic animals are desired to have at the time of harvest. Obtaining this target color may simply be performed by retrieving the target color from a database.

Then, step 42 is performed which comprises determining a light recipe. In the first iteration, the light recipe may simply be some default recipe, meaning that it is a default light recipe for the specific species of aquatic animals that are being grown. In further, iterations, an updated light recipe will be determined using a model (as output by step 66) associating characteristics of light provided to the aquatic animals to effects on color and/or color development of the aquatic animals, as will be explained in more detail below. The light recipe indicates, for each of a plurality of times, an electromagnetic spectrum and/or radiant flux of artificial light.

In step 44, the desired color trajectory is determined which indicates how the color of the aquatic animals is desired to develop. The desired color trajectory and the determined light recipe in step 42 are connected to each other in the sense that the desired color trajectory is the expected color development when the light recipe determined in step 42 is applied.

In step 46, the determined light recipe is provided to the aquatic animals so as to influence the color of the aquatic animals towards the target color. This step can be performed by sending appropriate control signals to an illumination system described herein.

After the light recipe has come into effect, the existing color of the aquatic animals is measured (step 48) meaning that existing color information is obtained which indicates an existing color of the aquatic animals, as well as further parameters (step 50).

For step 48, a computer vision algorithm may be performed which causes the controller to process images to localize fishes/shrimps and quantify their current body colors. In case of salmon, body color is observed from underwater images and flesh color may be observed from mobile phone images (e.g., generated by the farmer) of fillet of sampled fish. A statistical summary of animal's body colors may be made for a time period. A computer vision-based algorithm may thus be used to estimate true color of live animal in the water. At the time of imaging, several techniques may be used for maximizing the quality of the image. The aquatic animals may be drawn towards the camera by manipulating lighting and sound environment. Also, rapid locomotion actions may be induced, such as shrimp's tail flipping so that the animal is in a vantage point for high quality imaging. Also, the animals may be photographed from feeding constructs such as feeding tray and feeding boxes.

Step 48 may be repeated at different times of day and a summary of animal's body color may be made for a longer period (say 60 min). Current animal activities (such as feeding, burrowing, molting etc.) may be considered while sampling at different times of day to estimate true color of representative population. To address the problem of finding true body color in murky water, active lighting may be employed with a reference object. For example, a reference object may be placed inside the volume of water that represents the shrimp of desired color for a given day in the shrimp's growth cycle. Image recognition techniques may then detect and extract observed color from this reference object and use that information to understand true body color of shrimps. This approach overcomes practical challenges such as constantly varying turbidity, reflected wavelengths and light levels inside the water body.

The parameters may relate to the lighting conditions (however this is not strictly necessary since the lighting conditions are controlled and therefore known) and preferably also to any or all of
a turbidity of the water,
a velocity of the water,
a water temperature,
an amount of oxygen in the water,
a pH of the water,
amount and/or type of pathogens in the water,
amount and/or type of probiotic microbes in the water,
amount and/or type of pathogenic microbes in the water.

If the target color is reached (this is checked in step 52, then (“Y”) step 54 may be performed comprising causing the harvest of the aquatic animals after which the method ends at 56.

If the target color is not reached, then (“N”) step 58 is performed which comprises comparing the existing color measured in step 48 with the desired color as indicated by the color trajectory determined in step 44. If this difference does not exceed some threshold value (this is checked in step 60—then (“N”) step 48 is performed again. The cycle of step 48, 52, 58 and 60 may be performed repeatedly, for example a few times per day.

If the difference between the existing color and the desired color is determined in step 60 to exceed some threshold value, then (“Y”) step 42 is performed again. In this second iteration, and in further iterations, the light recipe is determined based on the target color of the aquatic animals (obtained in step 41) and based on the existing color of the aquatic animals (measured in step 48) and based on a model (as output by step 66) associating characteristics of light provided to the aquatic animals to effects on color and/or color development of the aquatic animals. Preferably, the light recipe is also determined based on the values of the parameters as measured in step 50.

Steps 61, 62, 64, 66 are not necessarily performed as part of the method. However, these steps indicate how the model can be obtained that is used for determining the light recipe. In step 61, lighting conditions are measured. In step 62, parameters are measured, preferably the same parameters as are measured in step 50. Step 64 comprises measuring the color of aquatic animals. Steps 62 and 64 may be performed on various historical batches and serve to gather training data on how the measured parameters correlate with the color development of the aquatic animals. Machine learning methods known in the art may be used to find these correlations and to construct the model in step 66. It should be appreciated that the color development and associated parameters that are measured in steps 48 and 50 may be input as training data as well into step 66, which provides for continuous improvement of the model.

With the determination of the new light recipe in step 42, also an associated color trajectory is determined (step 44). It should be appreciated that these steps may be performed at the same time. For example, it may be that the method may determine several candidate light recipes and determine for each candidate light recipe the associated color trajectory. Then, the candidate light recipe that has the best color trajectory, for example in terms of reaching the target color at the future time, may be selected as light recipe that is going to be implemented in step 46.

Performing step 46 may comprise controlling spotlights (optionally with tunable spectrum and dimmable control) to change illumination direction and/or levels and color of incident/reflected light in water body. Additionally or alternatively, performing step 46 may comprise controlling wall grazing luminaires (with tunable spectrum and dimmable control) to counter unwanted reflections originating from wall liner. For example, such luminaires can compensate for the non-reflecting dark liners in the tank.

As shown, steps 42, 44, 46, 48, 50, 52, 58, 60 may be performed repeatedly in a cycle until the target color is reached, which is checked in step 52. Thus, the light recipe may be adjusted repeatedly during the lifecycle of the batch.

Determining based on the current color appearance of the salmon fillet and the shrimp the desired concentration of the probiotic microbe. For instance, as is shown in FIG. 2, the color of the salmon fillet is influenced by Bacillaceae. The action spectra of Bacillus pumilus within water is available from literature. This enables us to purposefully choose a lighting wavelength to selectively promote the Bacillus pumilus, which positively contributes to the color appearance of the salmon fillet, with respect to other microbes present in the water (see our patent applications on microbiome)

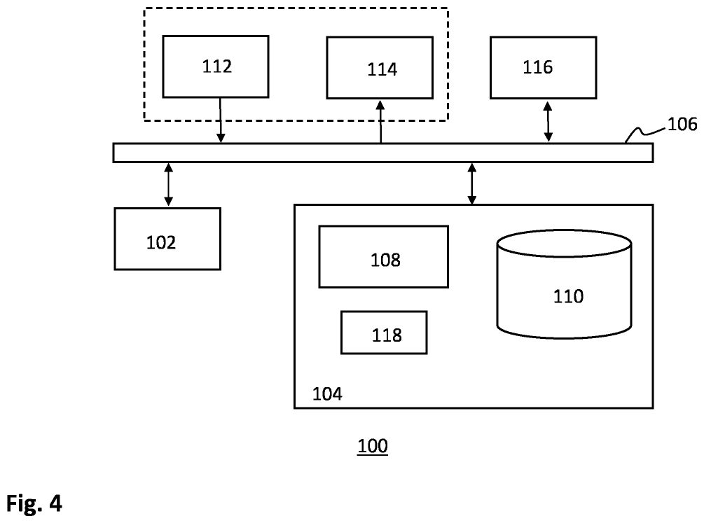

FIG. 4 depicts a block diagram illustrating a data processing system according to an embodiment.

As shown in FIG. 4, the data processing system 100 may include at least one processor 102 coupled to memory elements 104 through a system bus 106. As such, the data processing system may store program code within memory elements 104. Further, the processor 102 may execute the program code accessed from the memory elements 104 via a system bus 106. In one aspect, the data processing system may be implemented as a computer that is suitable for storing and/or executing program code. It should be appreciated, however, that the data processing system 100 may be implemented in the form of any system including a processor and a memory that is capable of performing the functions described within this specification.

The memory elements 104 may include one or more physical memory devices such as, for example, local memory 108 and one or more bulk storage devices 110. The local memory may refer to random access memory or other non-persistent memory device(s) generally used during actual execution of the program code. A bulk storage device may be implemented as a hard drive or other persistent data storage device. The processing system 100 may also include one or more cache memories (not shown) that provide temporary storage of at least some program code in order to reduce the number of times program code must be retrieved from the bulk storage device 110 during execution.

Input/output (I/O) devices depicted as an input device 112 and an output device 114 optionally can be coupled to the data processing system. Examples of input devices may include, but are not limited to, a keyboard, a pointing device such as a mouse, a touch-sensitive display, an imaging system described herein configured to measure the color of aquatic animals, or the like. Examples of output devices may include, but are not limited to, a monitor or a display, speakers, an illumination system for providing artificial light to the aquatic animals as described herein, or the like. Input and/or output devices may be coupled to the data processing system either directly or through intervening I/O controllers.

In an embodiment, the input and the output devices may be implemented as a combined input/output device (illustrated in FIG. 4 with a dashed line surrounding the input device 112 and the output device 114). An example of such a combined device is a touch sensitive display, also sometimes referred to as a “touch screen display” or simply “touch screen”. In such an embodiment, input to the device may be provided by a movement of a physical object, such as e.g., a stylus or a finger of a user, on or near the touch screen display.

A network adapter 116 may also be coupled to the data processing system to enable it to become coupled to other systems, computer systems, remote network devices, and/or remote storage devices through intervening private or public networks. The network adapter may comprise a data receiver for receiving data that is transmitted by said systems, devices and/or networks to the data processing system 100, and a data transmitter for transmitting data from the data processing system 100 to said systems, devices and/or networks. Modems, cable modems, and Ethernet cards are examples of different types of network adapter that may be used with the data processing system 100.

As pictured in FIG. 4, the memory elements 104 may store an application 118. In various embodiments, the application 118 may be stored in the local memory 108, the one or more bulk storage devices 110, or apart from the local memory and the bulk storage devices. It should be appreciated that the data processing system 100 may further execute an operating system (not shown in FIG. 4) that can facilitate execution of the application 118. The application 118, being implemented in the form of executable program code, can be executed by the data processing system 100, e.g., by the processor 102. Responsive to executing the application, the data processing system 100 may be configured to perform one or more operations or method steps described herein.

In one aspect of the present invention, the data processing system 100 may represent a controller as described herein.

Various embodiments of the invention may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 102 described herein.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration but is not intended to be exhaustive or limited to the implementations in the form disclosed. Many modifications and variations will be apparent to those of ordinary skill in the art without departing from the scope and spirit of the present invention. The embodiments were chosen and described in order to best explain the principles and some practical applications of the present invention, and to enable others of ordinary skill in the art to understand the present invention for various embodiments with various modifications as are suited to the particular use contemplated.

1. A computer-implemented method for controlling conditions within a volume of water containing aquatic animals, the method comprising:
obtaining target color information indicating a target color of the aquatic animals in the volume of water, and
obtaining existing color information indicating an existing color of the aquatic animals in the volume of water, and
based on the target color of the aquatic animals and based on the existing color of the aquatic animals and based on a model associating characteristics of light provided to the aquatic animals with effects on color and/or color development of the aquatic animals, determining a light recipe for the aquatic animals, and
providing the determined light recipe to the aquatic animals, so as to influence the aquatic animals' color towards the target color.

2. The method according to claim 1, further comprising:
constructing the model based on training data, the training data associating a plurality of light recipes with respective effects on color of aquatic animals, and
using the constructed model to determine the light recipe.

3. The method according to claim 2, wherein the training data further associating one or more parameters with respective effects on color of aquatic animals, the method further comprising:
measuring one or more values of the one or more parameters, and
using the constructed model and based on the measured one or more values of the one or more parameters, to determine the light recipe, wherein the one or more parameters comprise at least one of
a turbidity of the water,
a velocity of the water,
a water temperature,
an amount of oxygen in the water,
a pH of the water,
amount and/or type of pathogens in the water,
amount and/or type of probiotic microbes in the water,
amount and/or type of pathogenic microbes in the water,
amount and/or type of feed.

4. The method according to claim 1, wherein,
the light recipe indicates, for each of a plurality of times, an electromagnetic spectrum and/or radiant flux of artificial light, and wherein providing the determined light recipe to the aquatic animals comprises causing an illumination system to provide artificial light to the aquatic animals in accordance with the light recipe.

5. The method according to claim 1, wherein the method comprises determining, based on the target color of the aquatic animals and based on the existing color of the aquatic animals and based on a model associating characteristics of feed provided with the aquatic animals to effects on color and/or color development of the aquatic animals, feed, in particular characteristics of feed, for the aquatic animals.

6. The method according to claim 1, wherein,
the target color information indicates the target color of the aquatic animals for a future time, and
the existing color information indicates the existing color of the aquatic animals for a particular time before the future time, and the method further comprising:
obtaining desired color trajectory information indicating how the color of the aquatic animals is desired to develop in a time period before the future time such that the aquatic animals have the target color at the future time and indicating for each of one or more times before the future time, a desired color of the aquatic animals, wherein the one or more times comprise the particular time, and
based on a comparison between the existing color of the aquatic animals at the particular time as indicated by the existing color information and the desired color of the aquatic animals at the particular time as indicated by the desired color trajectory information, determining the light recipe, and
providing the determined light recipe to the aquatic animals.

7. The method according to claim 6, further comprising:
based on the determined light recipe, determining second color trajectory information indicating how, by providing the determined light recipe, the color of the aquatic animals is desired to develop in a time period between the particular time and the future time and indicating, for each of one or more times between the particular time and the future time, a desired color of the aquatic animals, wherein the one or more times comprise a second particular time,
obtaining second existing color information indicating the existing color of the aquatic animals for the second particular time between the particular time and the future time, and
comparing the existing color of the aquatic animals for the second particular time as indicated by the second existing color information and the desired color of the aquatic animals at the second particular time as indicated by the second color trajectory information.

8. The method according to claim 7, further comprising:
based on comparing the existing color of the aquatic animals for the second particular time as indicated by the second existing color information with the desired color of the aquatic animals at the second particular time as indicated by the second color trajectory information, determining a second light recipe, and
providing the determined second light recipe to the aquatic animals so as to influence the aquatic animals' color towards the target color.

9. The method according to claim 7, wherein,
the determined second color trajectory information indicates a time of harvest for the aquatic animals.

10. The method according to claim 1, wherein the aquatic animals comprise crustaceans.

11. The method according to claim 1, wherein the aquatic animals comprise fish, preferably salmon.

12. A controller that is configured to:
control an illumination system that is configured to provide artificial light to aquatic animals contained in a volume of water, the controller comprising:
an input interface for obtaining target color information indicating a target color of the aquatic animals in the volume of water and for obtaining existing color information indicating an existing color of the aquatic animals in the volume of water, and
a processor configured to determine, based on the target color of the aquatic animals and based on the existing color of the aquatic animals and based on a model associating characteristics of light provided to the aquatic animals with effects on color and/or color development of the aquatic animals, a light recipe for the aquatic animals, and
an output interface for sending control signals to the illumination system for causing the illumination system to provide artificial light to the aquatic animals in accordance with the light recipe.

13. A system for controlling conditions within a volume of water containing aquatic animals, the system comprising:
an illumination system that is configured to provide artificial light to the aquatic animals, and
a controller according to claim 12.

14. The system according to claim 12, further comprising:
one or more imaging systems that are configured to measure the existing color of aquatic animals within the volume of water.

15. A non-transitory computer readable medium comprising instructions which, when the instructions are performed by a processor of a system cause the system to perform the method according to claim 1.
